(19) United States
(12) Patent Application Publication
(10) Pub. No.: US 2008/0092092 A1
(43) Pub. Date: Apr. 17, 2008

(54) Method and Processor for Power Analysis in Digital Circuits

(76) Inventors: Damian Jude Dalton, County Dublin (IE); Hugo Michael Leeney, Dublin (IE); Abhay Vadher, County Dublin (IE)

Correspondence Address: HOLLAND & KNIGHT LLP, 10 ST. JAMES AVENUE, 11th Floor, BOSTON, MA, 02116-3889, US

(21) Appl. No.: 11/576,654

(22) PCT Filed: Oct. 4, 2005
(86) PCT No.: PCT/IE05/00111

§ 371 Date: Dec. 12, 2007

(30) Foreign Application Priority Data
Oct. 4, 2004 (IE) S2004/0671

(51) Int. Cl. G06F 17/50

(52) U.S. Cl. 716/4

(57) ABSTRACT

This invention relates to a method and processor (19) for power analysis in digital circuits. The method incorporates a main processor (19) and an associative memory mechanism (101a, 101b, 102, 104, 105, 106), the associative memory mechanism comprising a plurality of associative arrays (101a, 101b), an input value register (102), at least one result register (104) and a memory block area (29). A circuit design is transformed into a functionally equivalent model format suitable for processing in the associative array and thereafter input vectors are applied to the circuit and a record is kept of the inputs and or the outputs on each of the gates in the circuit over a specified time period. In this way, it is possible to calculate the leakage power dissipation as well as both the toggle dynamic power and the transition dynamic power.

This invention relates to a method and a processor for determining the power dissipation characteristics in a digital circuit.

One of the most important considerations when designing digital circuits is the power consumption and more specifically the power dissipation characteristics of that digital circuit. The power dissipation characteristics are central to the design of many digital circuits as they determine amongst other things the power supply that will be required to operate the circuit as well as the amount of heat that will be generated by that circuit. Many of these digital circuits may be implemented in mobile applications such as mobile telephony whereby the amount of power drawn off a battery supply is crucial in the design process. It is therefore vital to be able to accurately simulate the power dissipation characteristics of a particular circuit design before going to the effort and expense of realizing that circuit and subsequently carrying out tests thereon. It is also important that this simulation of the power dissipation characteristics is carried out in a fast and computationally efficient manner.

Heretofore, there have been proposed numerous methods of simulating the power dissipation characteristics of digital circuits. These may be grouped into two principle methodologies namely, Probability Techniques (Weakly Pattern Dependent) and Statistical Techniques (Strongly Pattern Dependent). There are however, problems associated with each of these methods.

Firstly, by using Probability Techniques (Weakly Pattern Dependent), instead of simulating circuits for a large number of cycles and averaging the results, this can be replaced by one run of a probabilistic analysis tool. Probability measures/metrics for testbenches and components in the design must be constructed. Signal probabilities for waveforms and Transition probabilities for internal nodes are directly propagated into the circuit and therefore special gate and cell models must be developed. Some methods inherently use a zero delay model and therefore are devoid of toggle power contributions. (Toggle Power is the condition when the output of a device changes several times in the one cycle. Essentially therefore, toggle power is dynamic power for multiple output transitions.) Other techniques in this category are based on Binary Decision Diagrams (BDDs) and Boolean Differences, these are computational prohibitive for large circuits containing hundreds of thousands of gate circuits. Spatial and Temporal correlation is also difficult to determine for circuits using probability techniques and may contribute significantly to the power consumption.

Common probability measures are the Signal Probability, Pₛ, and the Transition Probability, Pₜ. These are defined as follows: Pₛ(x) at a node x is the average fraction of clock cycles in which the steady state value of x is logic high. Pₜ(x) is the average fraction of clock cycles in which steady state values of x are different from its initial value. Both of these entities ignore circuit delays and consequently these measures are not suitable for estimating toggle power. Effectively they are zero delay models and calculate the average power of the circuit, Pₐᵥ, as:

Pₐᵥ=1/2T_{c}V²_{dd}Σⁿᵢ₌₁CᵢPᵢ(xᵢ)

Where T_{c} is the clock period and Cᵢ is the total capacitance at xᵢ. N is the total number of circuit nodes. This assumes at most a single transition/cycle and therefore puts a lower bound on the true average power. In general, the accuracy in power estimates delivered by these methods is limited by the quality of the delay models and the reality of the input specified.

The other methods employed in power analysis are Statistical Techniques (Strongly Pattern Dependent). These use traditional simulation techniques and simulate the circuit for a limited number of randomly generated input vectors. The number of input vectors depends on the sample estimates of the average power and their distribution. The major issues in these techniques are the speed of computation and the selection of input vectors which permit the calculated average power to converge close enough to the true average power. Normally, inputs are randomly selected and Monte Carlo statistical strategies used to terminate iterations. For global circuit power values, the Monte Carlo methods may only need a few hundred randomly selected input vectors to give good power convergence (<5% error). However, it may require several thousand cycles to calculate accurately the average power of individual modules in the circuit.

The majority of the power estimation tools available use behavioral or Register Transfer Level (RTL) models that are augmented with power macro models which use input signal probability and transition density functions. While the actual computations of these methods are relatively fast, the results of the probabilistic methods are typically in a window having an error margin of between 10% and 80%. More accurate statistical techniques involving gate level simulation are possible but they are heretofore not realistically feasible due to the enormous computational load for large circuits.

Another problem associated with determining the power dissipation characteristics in a digital circuit arises out of the nature of the circuits themselves. Heretofore, the majority of the testing of digital circuits has been carried out on digital circuits based around CMOS and BiCMOS components whose feature size is of the magnitude of 1 micron or greater. These devices only consume power through output transitions. Therefore, the power consumption is input pattern dependent. These features allow certain assumptions to be made about the behavior of the circuit and the following physical model may be applied in the analysis of such circuits:
i) Power supply lines and ground are fixed.
ii) Sequential circuits are Synchronous.
iii) Steady state current is negligible.
iv) Average power is attributable to power consumed by latches/Flip-Flops at clock edges and output transitions of combinational gates.
v) Race conditions cause glitches which generate Toggle Power. Many estimators ignore this entity as they use zero delay simulation. Typically, toggle power dissipation is 20% of total power but can be as high as 70% of total consumption.
vi) Short-circuit current during transitions is negligible.

This model leads to a relatively easier simulation of the circuit. However, many of the digital circuits undergoing analysis nowadays contain components with feature sizes of less than 1 micron. This introduces some additional important considerations. First of all, to avoid hot carrier effects the supply voltage must be reduced. However, in order to maintain or improve circuit speed, the ratio of supply voltage to threshold voltage must be 5 or greater otherwise the current drive capability of the gates is severely diminished. Thus, the threshold voltage is reduced with the unfortunate side-effect that there is a large increase in standby current, otherwise referred to as Leakage Current.

For sub-micron devices, leakage power is the same order of magnitude as dynamic power (i.e. transition and toggle power). Therefore, it is a significant factor in sub-micron devices. Consequently in sub-micron devices, dynamic and leakage power must be integrated into the power analysis, if the power assessment is to be accurate. The two main mechanisms contributing to leakage power are subthreshold leakage and PN-junction leakage. Subthreshold leakage has an exponential relationship with the threshold voltage and at the moment is the sole consideration in leakage current. PN-junction leakage on the other hand is a function of junction area and doping concentration and is insignificant. For ultra deep submicron devices Gate oxide tunneling is a significant contributor to leakage current.

Leakage effects can be determined at a transistor level of abstraction of the cells used in a design. Ultimately, they manifest themselves as input state dependent power models of the circuit's cells. A typical cell from the TSMC 0.18 micron library is shown in Table 1 below.

TABLE 1
Leakage current for 4-input NAND gate, TSMC 0.18 micron library.

| Input Pattern | Leakage Current (nA) |
|---|---|
| 0111 | 9.96 |
| 1011 | 6.86 |
| 0001 | 0.98 |
| 0000 | 0.72 |
| 0101 | 0.0045 |
| 1101 | 0.0241 |
| 0011 | 1.71 |

Leakage current, also known as State-dependent power, is a static phenomenon. The output of the device is stable. Unlike dynamic or toggle power, which can be calculated in a logic simulation model by identifying output gate transitions, leakage power requires the input vector state of a static device to be determined. Therefore, in the simulation process, it is not possible to determine leakage current through the detection of output transitions, but rather through the determination of the input state of each device. Incorporating leakage current into power analysis tools has only recently been undertaken, in a transistor model of a circuit. Synopsys Power Compiler (Registered Trade Mark (RTM)) is an example of such a tool. Using the average cell leakage current in a design, a linear model, the equation of which is shown below, has been devised for predicting global average power:

In Pₗₑₐₖ=S^{lib}In (No. Cells)+C^{lib}

In this approach, the model only requires information on the number of cells in the design, for a given target technology. S^{lib} and C^{lib} are calculated from the transistor characterization of the cell technology. While, this techniques has cited benchmarks that are accurate to within 2% of values calculated by other design tools, average errors are 10-20% and in some cases the error has been in excess of 80%. What is required therefore is an accurate method and processor that will enable both the dynamic and the leakage current to be measured in an efficient and accurate manner.

It is an object of the present invention to provide a method and a processor for power analysis in digital circuits that overcomes at least some of these difficulties and that is both relatively accurate and efficient in operation.

### STATEMENTS OF THE INVENTION

A method of determining the power dissipation characteristics of a digital circuit in a processor comprising a main processor and an associative memory mechanism, the associative memory mechanism comprising a plurality of associative arrays, an input value register, at least one result register and a memory block area, the method comprising the steps of:
providing a digital circuit design for analysis, the circuit design containing a plurality of components complete with a component library containing power dissipation characteristics for each of the components in the circuit design;
parsing the digital circuit design to create a functionally equivalent model in a format suitable for manipulation in the main processor and associative memory mechanism, the functionally equivalent model containing a plurality of primitive types, each primitive type having at least one input gate and an output gate;
storing the functionally equivalent model in the associative memory mechanism;
providing at least one input vector to the functionally equivalent model and determining which of the primitive types undergo a change in one or more of the gate values in response to the input vector applied;
storing a record of values on each of the gates of the primitive types in response to the applied input vector; and
calculating the power dissipation of the model by comparing the power dissipation characteristics with the record of values on each of the gates of the primitive types.

By having such a method, it will be possible to calculate the static power and the dynamic power of a circuit in a simple and efficient manner. In particular, it is possible to calculate the transition dynamic power and the toggle dynamic power components which was heretofore not possible using the known techniques. Furthermore, the power dissipation calculation will be both accurate and fast and will not require excessive computational power to allow the circuits to be analysed in a comprehensive manner.

A method of determining the power dissipation characteristics of a digital circuit in which the method comprises the step of determining the primitive types that have undergone a change in output gate value and calculating the transition dynamic power consumption for those primitive types. This is a particularly simple way of determining the dynamic transition power that is particularly simple to implement in a modified processor with associative memory mechanism according to the present invention.

A method of determining the power dissipation characteristics of a digital circuit in which the method further comprises the step of storing a record of all transitions in a primitive types output over a simulation time unit (STU) and calculating the toggle dynamic power consumption for that primitive type. In this way, it will be possible to calculate the toggle power for a device which was heretofore not possible using the existing systems and methods. This will enable a more accurate analysis to be carried out.

A method of determining the power dissipation characteristics of a digital circuit in which the method further comprises the step of determining the nature of the transition of the output and thereafter calculating the dynamic power consumption based on the nature of the transition. This is seen as useful as the transition dynamic power may differ from a 0 to 1 transition to a 1 to 0 transition and therefore a more accurate analysis is possible.

A method of determining the power dissipation characteristics of a digital circuit in which the method further comprises the step of storing a record of all input gate values for a primitive type and calculating the leakage power consumption for that primitive type. Again, by storing the values of the inputs, it is possible to calculate the values of static or leakage power dissipation in a simple manner that is not computationally expensive.

A method of determining the power dissipation characteristics of a digital circuit in which the step of calculating the power dissipation of the model further comprises calculating both the dynamic power dissipation and the leakage power dissipation.

A method of determining the power dissipation characteristics of a digital circuit in which the method further comprises the step of segmenting the functionally equivalent model into a plurality of cache blocks, each of the cache blocks containing a plurality of related primitive types. This is seen as highly advantageous as the cache blocks may be brought into the associative memory mechanism and tests may be carried out on all the components of one type at the same time thereby reducing the computation overhead and simplifying the procedure.

A method of determining the power dissipation characteristics of a digital circuit in which the step of segmenting the circuit into a plurality of cache blocks, each of the cache blocks containing a plurality of related primitive types further comprises separating the primitive types into cache blocks based on whether the primitive types are synchronous or combinational.

A method of determining the power dissipation characteristics of a digital circuit in which the step of segmenting the circuit into a plurality of cache blocks, each of the cache blocks containing a plurality of related primitive types further comprises separating the primitive types which form a single module into a cache block together. Furthermore, a module may span a number of cache blocks in which case each of the cache blocks would form part of the module.

A method of determining the power dissipation characteristics of a digital circuit in which the method comprises the intermediate step of generating a power activity frame prior to calculating the power dissipation of the model, the power activity frame comprising a list of all primitive types that have undergone a transition in their gate value.

A method of determining the power dissipation characteristics of a digital circuit in which the method further comprises the intermediate step of transmitting the power activity frame for each cache block to a host PC and the steps of calculating the power dissipation for each cache block based on the power activity frame corresponding to that cache block and thereafter calculating the power dissipation for the entire circuit are carried out on the host PC. In this way, it is possible to carry out the power dissipation calculations themselves on the host PC and the computational burden of toting up the power dissipation and other factors will be offloaded from the processor allowing the processor to work at near optimum levels.

A method of determining the power dissipation characteristics of a digital circuit in which the power activity frames are transferred to the host PC after each cycle.

A method of determining the power dissipation characteristics of a digital circuit in which the method further comprises the steps of:
deriving a library characterisation file (LCF) from the component library, the LCF specifying the power dissipation characteristics of each of the primitive types of the functionally equivalent model; and
generating a transition count file (TCF) that lists the number of transitions on each of the gates of the primitive types per simulation time unit (STU); and
calculating the power dissipation of each STU by comparing the LCF with the TCF.

This is seen as particular efficient as the power estimation can be carried out in a very quick and simple manner.

A method of determining the power dissipation characteristics of a digital circuit in which the step of parsing the digital circuit design to create a functionally equivalent model further comprises generating an Apples to Design cell relational Database (ADD) containing the relationships between the components of the digital circuit design with the primitive types of the functionally equivalent model, and a Design Cell Database (DCD) containing a list of components of the original digital circuit design, the method further comprising the steps of:
generating an Apples Model Value Change File (AMVCF) containing a list of gate value changes of primitive types in the functionally equivalent model;
processing the AMVCF entry by entry and for each entry in the AMVCF, using the ADD to determine which of the components in the original digital circuit design the entry in the AMVCF relates to; and
retrieving that component from the DCD and thereafter calculating the power dissipation of that component using the component library.

This on the other hand is seen as beneficial as the processor will use the library that has been provided by the manufacturer of the technology being tested and therefore the test results will be very accurate indeed, perhaps as accurate as the library will allow. Furthermore, the method will allow the processor to be freed up for other purposes.

A method of determining the power dissipation characteristics of a digital circuit in which the step of applying an input vector to the circuit further comprises receiving an input vector from a host PC and applying that input vector to the circuit.

A method of determining the power dissipation characteristics of a digital circuit in which the step of applying an input vector to the circuit further comprises generating an input vector for application to the circuit.

A method of determining the power dissipation characteristics of a digital circuit in which the method is carried out on a cycle by cycle basis.

A method of determining the power dissipation characteristics of a digital circuit in which one of a simple functional or unit delay is used.

A method of determining the power dissipation characteristics of a digital circuit in which the step of calculating the power dissipation for the entire circuit further comprises determining the total power dissipation for each of the particular types of components in the circuit and thereafter summing the total power dissipation for each type of component with the total power dissipation for all the other types of components.

A method of determining the power dissipation characteristics of a digital circuit in which the step of calculating the power dissipation for the entire circuit further comprises determining the total number of gates undergoing a transition regardless of gate type and using an approximation of a mean gate power dissipation value to calculate the power dissipation.

A method of determining the power dissipation characteristics of a digital circuit in which a plurality of primitive components may be grouped in a complex cell and the method further comprises the step of determining the power dissipation of the complex cell based on a predetermined power characteristic for that cell.

A method of determining the power dissipation characteristics of a digital circuit in which the method further comprises the initial step of levelising the circuit to be evaluated.

A method of determining the power dissipation characteristics of a digital circuit, in a processor comprising a main processor and an associative memory mechanism, the associative memory mechanism further comprising a plurality of associative arrays, at least one result register and a memory block area, the memory block area being capable of storing a plurality of power activity frames (PAF), the power activity frames representing the status of individual components forming the digital circuit, the method comprising the steps of:
segmenting the circuit into a plurality of cache blocks, each of the cache blocks containing a plurality of related components;
storing the cache blocks in the associative memory mechanism;
applying an input vector to the circuit and determining which of the cache blocks will undergo a transition as a result of the input vector applied;
evaluating each cache block that undergoes a transition due to the application of the input vector and storing the results of the evaluation in a power activity frame in the memory block area; and
calculating the power dissipation for each cache block based on the power activity frame corresponding to that cache block and thereafter calculating the power dissipation for the entire circuit.

A processor for determining the power dissipation characteristics of a digital circuit comprising a plurality of components, the processor comprising a main processor and an associative memory mechanism, the associative memory mechanism comprising a plurality of associative arrays, an input value register, at least one result register and a memory block area, characterized in that the processor further comprises a parser for receiving a digital circuit design in a first format and creating a functionally equivalent model comprising a plurality of primitive types, each having at least one input gate and an output gate, in a second format suitable for manipulation in the main processor and associative memory mechanism.

A processor for determining the power dissipation characteristics of a digital circuit in which the processor further comprises means to store the power dissipation characteristics for primitive types of the functionally equivalent model and means to calculate the power dissipation of the primitive types of the functionally equivalent model.

A processor for determining the power dissipation characteristics of a digital circuit in which the processor further comprises means to generate an APPLES Model Value Change File (AMVCF) containing a list of transitions in the values of gates in the functionally equivalent model.

A processor for determining the power dissipation characteristics of a digital circuit in which the processor has means to generate a transition count file (TCF) comprising a list of the number of transitions of each of the gates of the primitive types for a given simulation time unit (STU).

A processor for determining the power dissipation characteristics of a digital circuit in which the processor has means to generate a library characterization file (LCF) from a received library file relating to a digital circuit design.

A processor for determining the power dissipation characteristics of a digital circuit in which the processor further comprises an APPLES to Design cell relational Database (ADD), a Design Cell Database (DCD) and a Hierarchy model (HM).

A processor for determining the power dissipation characteristics of a digital circuit in which the processor has means to access power dissipation characteristic tables of components of a digital circuit design and using the AMVCF, the ADD and the DCD, calculate the power dissipation for a digital circuit design.

A processor for determining the power dissipation characteristics of a digital circuit in which the processor further comprises a block activity counter, an active hit counter and a block dynamic activity table.

A processor for determining the power dissipation characteristics of a digital circuit in which the processor has means for receiving an input vector from a host PC for application to a circuit under test.

A processor for determining the power dissipation characteristics of a digital circuit in which the processor has means for generating an input vector for application to a circuit under test.

A processor for determining the power dissipation characteristics of a digital circuit in which the processor has means for transmitting activity data relating to gates to a host PC for further analysis by the host PC.

### DETAILED DESCRIPTION OF THE INVENTION

The invention will now be more clearly understood from the following description of some embodiments thereof, given by way of example only in which:

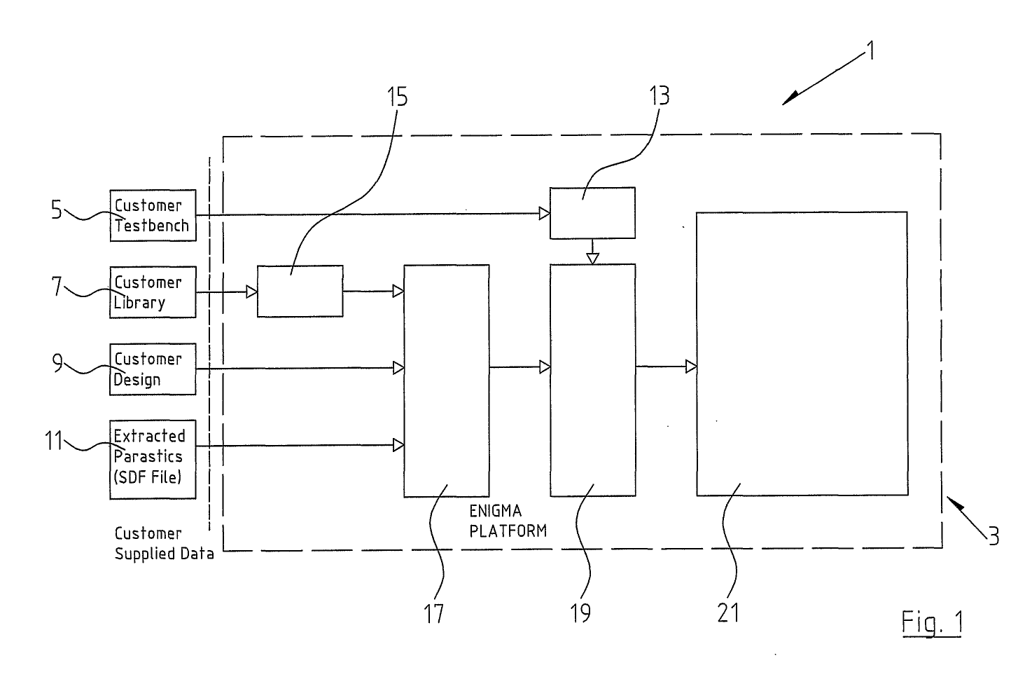

FIG. 1 is system overview of a system in which the analysis of digital circuits may be carried out;

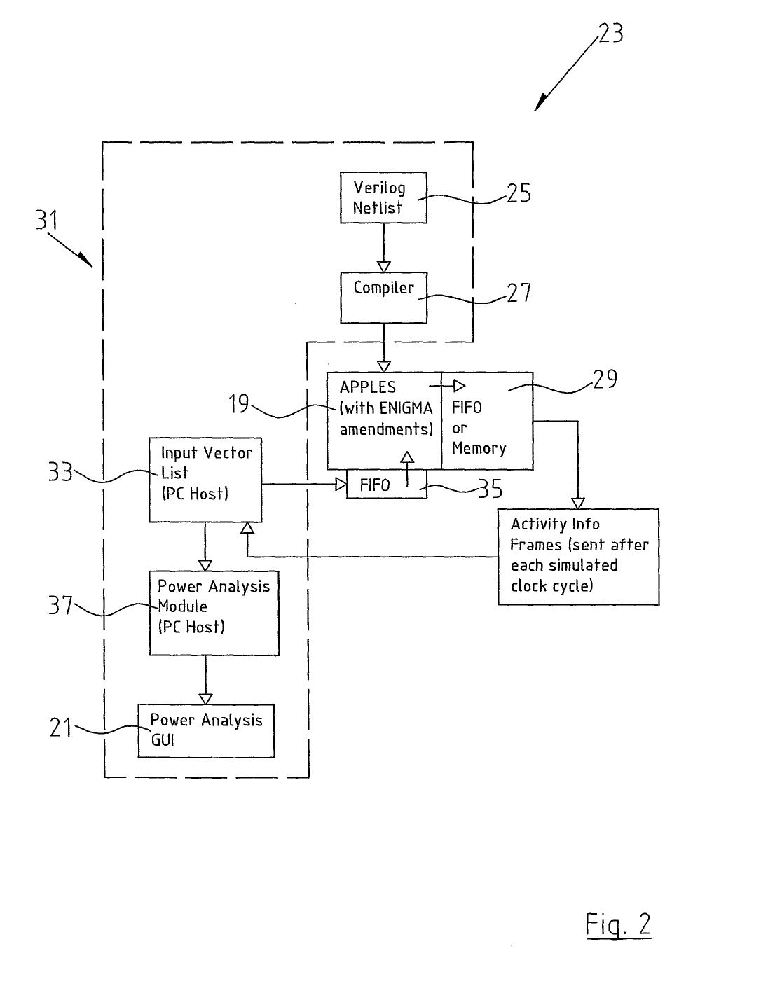

FIG. 2 is a block diagram of a system in which the analysis of digital circuits may be carried out incorporating the processor according to the present invention;

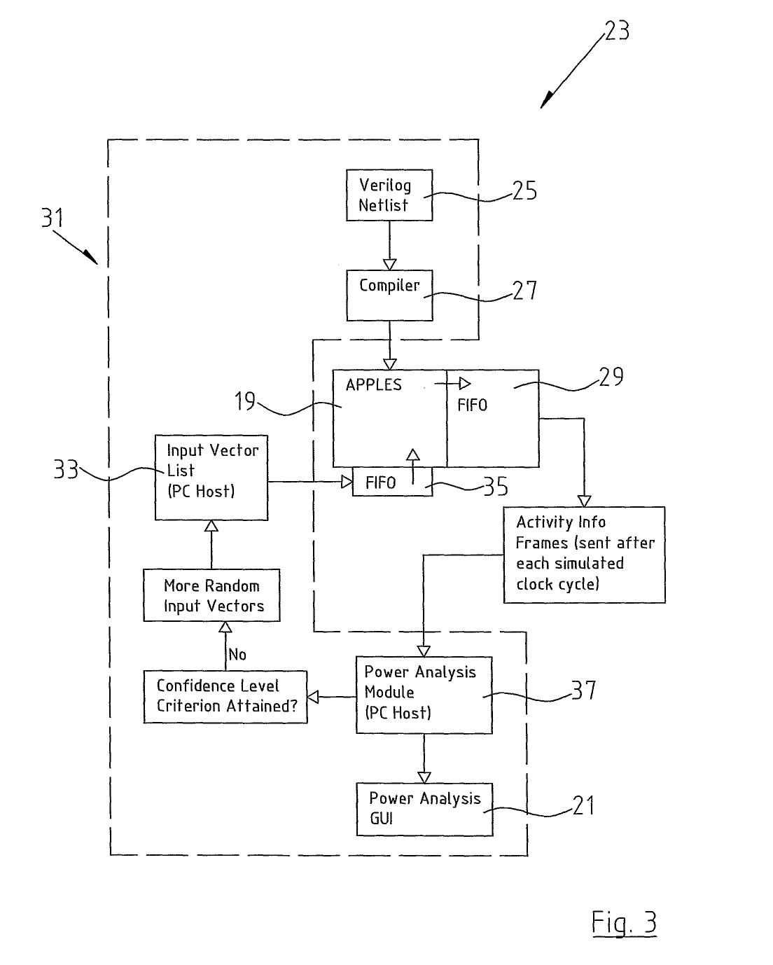

FIG. 3 is a block diagram of an alternative system incorporating the processor according to the present invention;

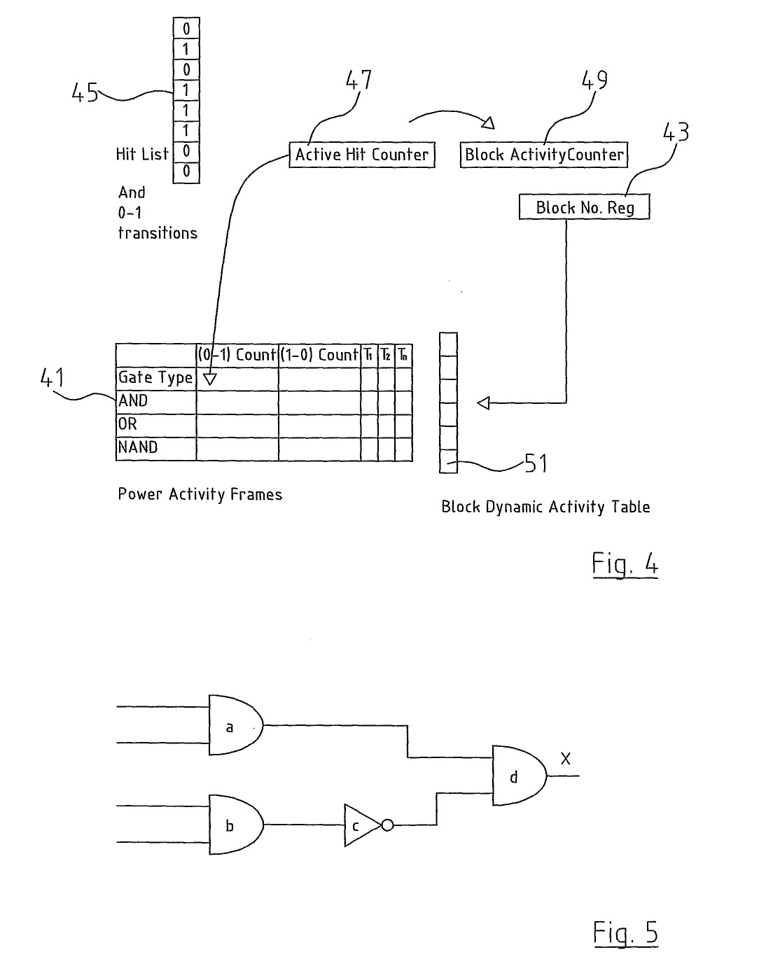

FIG. 4 is a block diagram of the additional registers incorporated into the processor of the present invention;

FIG. 5 is a component diagram of a complex cell which may be modeled using the method according to the invention;

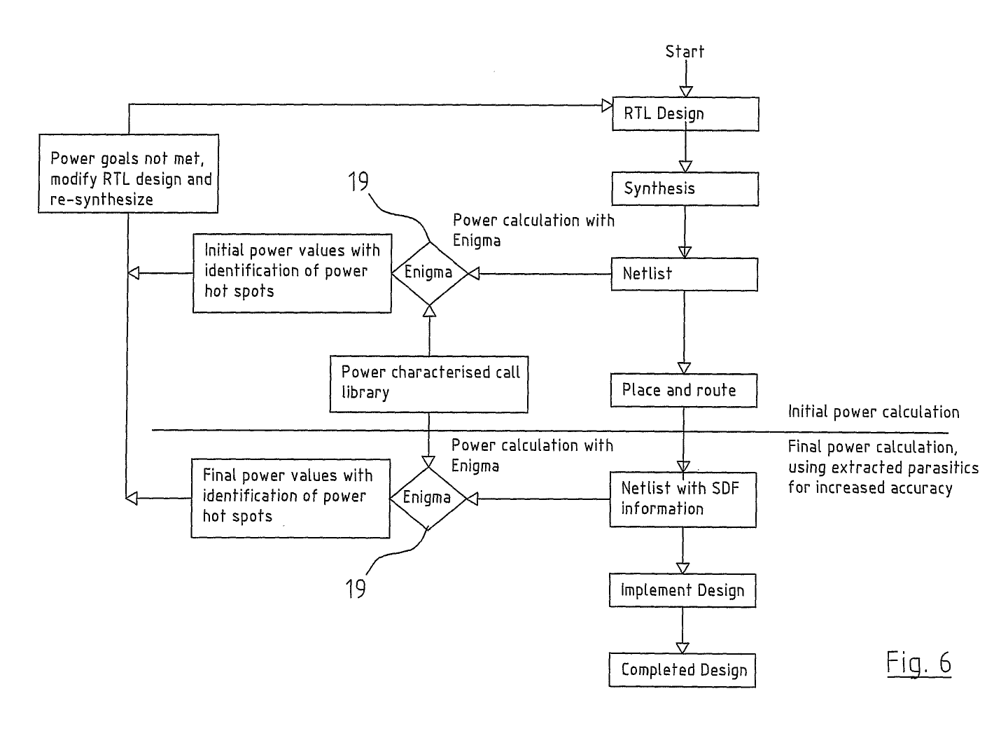

FIG. 6 is a block diagram of a typical design methodology with the processor and method according to the invention incorporated in the design flow; and

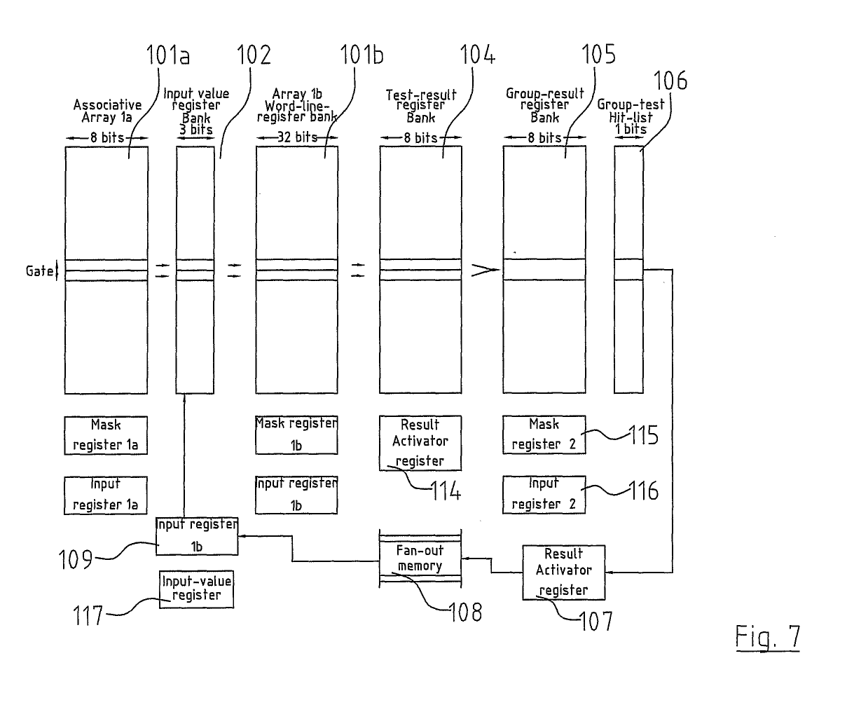

FIG. 7 is a block diagram of a processor with associative memory mechanism according to the prior art.

Referring to the drawings and initially to FIG. 1 thereof there is shown an overview of a system, indicated generally by the reference numeral 1, in which the analysis of digital circuits may be carried out. The system 1 incorporates an analysis system 3 for determining the power dissipation characteristics of a simulated digital circuit (not shown). Customer supplied data including customer testbench 5, customer library 7, customer design 9 and extracted parasitics (SDF file) 11, are fed to the analysis system 3. The analysis system 3 comprises a testbench acceleration module 13, a library compiler 15, a netlist compiler 17 and a modified APPLES processor 19 for first of all compiling the data into a useable format and thereafter analyzing the data received from the customer. The analysed data is thereafter sent to a host pc (not shown) where the data is collated into a report format for display on a graphical user interface 21.

In use, there are essentially two modes of operation of the modified processor affording different levels of performance to the user. Generally speaking, in both modes of operation, the user produces a number of text files that constitute a Verilog description of the circuit he or she intends to physically make. This is called the digital circuit design. The design is targeted towards a particular technology such as CMOS, BiCMOS or other technologies with smaller sized components. The manufacturer who offers this technology also produces a library in different formats that specify to a certain degree of accuracy the behavior of the elements of the library. These elements are typically referred to as cells and in a given library there will be cells of many different types. The digital circuit design is basically a list of connected cells. The designer will usually break his design into functional blocks called modules. Each module in turn may be broken down into its own component modules. A module hierarchy results from this procedure. The digital circuit design is submitted to the modified processor.

The ENIGMA tool, as the modified processor is otherwise referred to, is essentially made up of a simulation engine component and a power calculation component. The simulation engine comprises a parser and the APPLES simulation processor. The parser reads the design presented to it and creates a model (an APPLES model) of the design in a format that can be downloaded onto the modified APPLES simulation processor and processed. This model is functionally equivalent to the original design given certain constraints on the simulation complexity. The model is composed only of certain simple functional blocks that are called APPLES Primitive Types (APTs). The simulation engine outputs a list of value changes in the APPLES model to the host PC that is consolidated in a file called the APPLES Model Value Change File (AMVCF) by a software component.

In the first mode of operation, the modified APPLES simulation engine has an added capability to produce a file (called the transition count file TCF) that lists per simulation time unit (STU) how many transitions occurred on gates of each of the APTs. The ENIGMA power tool uses a file (called the Library Characterisation File (LCF)), derived from the library files of the technology the design targets, that specifies power consumption characteristics of each APPLES cell. Some processing is done and heuristics used to map from the library to the APPLES cells using some knowledge of what cells are used in the design. The ENIGMA tool then uses a simple iterative method to process the TCF and the LCF together to calculate the power consumed per STU using an equation also derived from the library. The advantage of this mode of operation of the ENIGMA processor is that it is fast and computationally efficient.

In the second mode of operation of the ENIGMA processor, the ENIGMA tool works in a different way to the first version. The modified APPLES processor is still a key component however the ENIGMA processor no longer uses the TCF to calculate power. Instead it uses the AMVCF. In this file every output change on an APPLES gate is identified individually. For every time step a list of gate numbers and values transitioned to is available. The power calculation then processes this data and produces a data structure that can be used to visualize the power calculation in any subset of the design modules. When the design is being parsed a number of databases describing pertinent design objects from the users Verilog description is created including the APPLES to Design cell relational Database (ADD), the Design Cell Database (DCB) and the Hierarchy Model (HD). The power calculation program uses this database to relate the information returned by the modified APPLES processor to the original design. By doing this the processor can calculate power accurately using the library the user is targeting rather than the library that has been generated for the equivalent circuit.

The processor processes the AMVCF entry by entry. For every entry it is aware of the time unit and it extracts the gate identifier (identifies an APPLES cell in the APPLES model) and the value identifier (identifies to which value the gate transitioned to). The software then determines from which cell in the users design this APPLES gate originated by fetching an entry from the ADD. It then finds this design cell in the DCB. The DCB can be annotated with any amount of information such as, interconnect capacitance, parent module specifier, state table for the cell instance. The design parser then annotates this database with all this instance specific information.

The type of design cell can also be determined from the DCD. A tool that processes a formal specification of the library that the user is targeting (typically written in a format such as Advanced Library Format) extracts information that is generic across design cells of the same type and relates this to the type identifier .found in the DCD. This information would also typically consist of constants for use in calculation of dynamic power and static power dissipation. It can also include the specific equation/algorithm that the library specifies should be used to calculate the power dissipation. Although the AMVCF only identifies output transitions, it is still possible to identify the static power dissipation as the vast majority of outputs are essentially connected to other gate inputs and it is possible to look up what inputs are affected by a particular output change. Therefore, it is possible to keep state tables for static power. Although it would be possible for the AMVCF to determine the input values that change this is deemed unnecessary. The remaining inputs of the system that are not connected to the output of another device are called primary inputs and it is possible to detect the static power dissipation of these devices by checking the input vectors that were supplied to the circuit. Therefore, all the required input data is readily available.

This entire mechanism is achieved using code generation and object oriented programming techniques. By doing this, the calculation is faithful to the library specification. When the design cell has been found in the DCD, the power consumption due to the output change detected by the modified APPLES processor can be calculated. Once this is done, the processor then adds this value to the total power dissipated by the parent module of the design cell (information extracted from the DCD) for the current time unit being analyzed. When the entire AMCVF has been processed, the modified processor has created a database (Power per Module per Time-unit Database PMTD) that has an entry for every time unit in the simulation, and each of these entries having an entry for every leaf module in the design. (A leaf module is one that contains only design cells.)

The user can then use interface software to report power consumption for any module in the design hierarchy for any subset of time units. The interface software uses a Hierarchy Database (HD) to find out which leaf modules make up the requested module. It then fetches the power consumption values for these modules from the PMTD for the requested subset of time units and adds them up. The main advantage of the second mode of operation is that the calculations are more accurate. Furthermore, using the second mode of operation, the accuracy of the per-module power consumption estimation is greatly improved. The modified APPLES processor will be freed from having to change to achieve components of the power calculation such as static power and module level visibility. This allows the operator to optimise the simulation for speed since the processor will no longer have to carry out tasks such as looking for states and building activity frames.

Referring now to FIG. 7 of the drawings, there is shown an APPLES processor having an associative memory mechanism known in the art. Before discussing the invention further it is deemed necessary to briefly discuss the APPLES processor and its functionality as it will enhance the understanding of the present invention. Referring to FIG. 7, the functional blocks of the APPLES processor are shown. The blocks pertinent to gate evaluation are associative array 101a, input-value-register bank 102, associative array 101b, test-result-register bank 104, group-result register bank 105 and the group-test hit list 106. The group test hit list in turn feeds a multiple response resolver 107 which in turn feeds a fan out memory 108 to an address register 109 connected to the input value register bank 102. The associative array 101a has an associative mask register 1a and input register 1a while the associative array 1b has a mask register 1b and an input register 1b. Similarly, the test result register bank 104 has a result activator register 114 and the group result register bank 105 has a mask register 115 and an input register 116. Finally, an input value register bank 117 is provided. Apart from the associative arrays, the group-result register bank has parallel search facilities. Regardless of the number of words in these structures can be searched in parallel in constant time. Furthermore, the words in the input-value-register bank 117 and associative array 101b can be shifted right in parallel while resident in memory.

A gate can be evaluated once its input wire values are known. In conventional uni-processor and parallel systems these values are stored in memory and accessed by the processor(s) when the gate is activated. In APPLES, gate signal values are stored in associative memory words. The succession of signal values that have appeared on a particular wire over a period of time are stored in a given associative memory word in a time ordered sequence. For instance, a binary value model could store in a 32-bit word, the history of wire values that have appeared over the last 32 time intervals. Gate evaluation proceeds by searching in parallel for appropriate signal values in associative memory. Portions of the words which are irrelevant (e.g. only the 4 most recent bits are relevant for a 4-unit gate delay model) may be masked out of the search by the memory's input and mask register combination. For a given gate type (e.g. And, Or) and gate delay model there are requirements on the structure of the input signals to effect an output change. Each pattern search in associative memory detects those signal values that have a certain attribute of the necessary structure (e.g. Those signals which have gone high within the last 3 time units). Those wires that have all the attributes indicate active gates. The wire values are stored in a memory block designated associative array 101b (word-line-register bank). Only those gate types relevant to the applied search patterns are selected. This is accomplished by tagging a gate type to each word. These tags are held in associative array 101a. A specific gate type is activated by a parallel search of the designated tag in associative Array 101a.

This simple evaluation mechanism implies that the wires must be identified by the type of gate into which they flow since different gate types have different input wire sequences that activate them. Gates of a certain type may be selected by a parallel search on gate type identifiers in associative array 101a. Each signal attribute corresponds to a bit pattern search in memory. Since several attributes are normally required for an activated gate, the result of several pattern searches must be recorded. These searches can be considered as tests on words.

The result of a test is either successful or not. This can be recorded as single bit in a corresponding word in another register held in a register bank termed the test-result-register bank. Since each gate is assumed to have two inputs (inverters and multiple input gates are translated into their 2-input gate circuit equivalents) tests are combined on pairs of words in this bank. This combination mechanism is specific to a delay model and defined by the result-activator register and consists of simple AND or OR operation between bits in the word pairs. The results of each combining each word pair, the final stage of the gate evaluation process, are stored as a single word in another associative array, the group-result register Bank 105. Active gates will have a unique bit pattern in this bank and can be identified by a parallel search for this bit pattern. Successful candidates of this search set their bit in the 1-bit column register group-test hit list.

The bits in each column position of every gate pair in the test-result register bank 104 are combined in accordance to the logic operators defined in the result-activator register. The bits in each column are combined sequentially in time in order to reduce the number of output lines in the test-result-register bank 104. Thus, there is only one output line required for each gate pair in the test-result register bank, instead of one wire for each column position. The result of the combination of gate pairs in the test-result register bank 104 are written column by column into the group-result register bank 105. Only one column in parallel is written at a particular clock edge. This implies only one input wire to the group-result register bank 105 is required per gate pair in the test-result register bank. This reduces the number of connections from the test-result register bank to the group-result register bank. The above is given merely by way of example of one mode of standard operation of an APPLES processor but it will be understood that the modified APPLES processor of the present invention is not limited to this mode of operation. The above is merely given as a brief description of a typical operation of this unique and very specific processor.

In addition to the above, it will be understood that throughout this specification, reference will be made to the APPLES processor and to methods of parallel processing for logic event simulation. These processors and the methods of simulation are described in depth in the applicants own previously filed applications and for reasons of brevity have not been recalled here in any further depth. Reference is made to the applicants own prior published applications namely PCT Patent Publication No. WO 01/01298 and PCT Patent Publication No. WO 03/079237, the disclosures of which are incorporated herein by way of reference. More specifically, the architecture of the APPLES processor and in particular it's operation as described in the above-identified applications are incorporated herein by reference.

Generally speaking, the modified APPLES processor is ideally suited for detecting output gate transitions. As a logic simulator its intrinsic simulation mechanism identifies active gates and this activity can be augmented to count and record gate types and their transitions to facilitate dynamic power consumption. Leakage current is not readily calculable by conventional event-driven simulators since it is an attribute of the steady state operation of gate cells. By definition no events are generated by the gates while in steady state. Nevertheless, in the modified APPLES system, input patterns can be identified at various gate types. For instance from Table 1 shown above, the input pattern 0111 can be identified by the successive application of four tests. The first test verifies that input pin 0 is 0 and the three following tests verify that pins 2, 3 and 4 are 1. In calculating leakage current, the lowest power for each cell is assumed but tests are applied to each cell type to determine the number of cells which have states of high power consumption. Unlike normal gate evaluation in APPLES, there is no fan-out propagation when steady state gate evaluation is being determined. It is only necessary to count the number of gate states. Further optimizations may be made considering two or more steady states to be equivalent if their power consumption is within a certain window, e.g. in Table 1 above, 0111 and 1011 may be assumed to be equivalent and have a power rating of 8 nA.

Referring now to FIG. 2 of the drawings, there is shown a block diagram of a system, indicated generally by the reference numeral 23, in which the analysis of digital circuits may be carried out, incorporating the processor 19 according to the present invention. A verilog netlist of components, 25, is passed through the compiler 27 to generate an APPLES equivalent circuit, which is passed to the processor 19 and stored in processor memory 29. The processor 19 essentially comprises a modified APPLES processor, which modifications will be described in greater depth below. A host PC, indicated generally by the reference numeral 31, has a list of input vectors in Input Vector List 33 stored in host PC memory and these are transmitted in sequence to the processor 19 where they are stored in a FIFO memory 35 before being applied to the circuit in the processor 19, thereby simulating the circuit. At the end of a cycle, power activity frames are produced and are stored in the processor memory 29, which is also a FIFO memory. At the end of each cycle, the power activity frames in the processor memory 29 are transferred to the host PC 31 for further manipulation. Alternatively, multiple power activity frames for the same cache block can be stored before transmission as a block. In this instance, each of the power activity frames will be distinguished by a time stamp. Both of these approaches will require an interrupt to be transmitted to the host PC indicating the arrival of power activity frames. On reception of the data, the host PC 31 passes the power activity frames to the power analysis module 37 wherein the host PC extracts the power frame data and analyses the power in the circuit on a cycle by cycle basis. In order to accurately calculate the energy levels in the circuit the cell library specified gate energy models of the synthesized circuit are used. From that various statistical measurements may be calculated. The power analysis is then displayed on a graphical user interface 21.

There are two main types of interaction between the modified APPLES processor and the software that generates the input stimuli, Simple and Interactive modes. In Simple Mode, the testbench is required to generate power estimates for the circuit, not to validate it. A predefined random set of input vectors is created, each to be applied at a specific cycle. These vectors are generated prior to simulation and are applied sequentially without any conditional interaction as would be expected in a simulation testbench. The input vector list on the host PC 31 transfers blocks of input vectors each with an appended time-stamp. This is stored in a time-ordered structure in the input FIFO 35 of the processor 19. When the FIFO 35 is emptied to a pre-defined level an interrupt is transmitted to the PC host 31. This interrupt initiates a new input data set to be transmitted from the host PC 31 to the FIFO 35. The process repeats until all input vectors from the host PC have been applied. In this mode it is also possible to generate random input vectors using a random pattern generator (not shown) on the modified APPLES processor 19. In this case no vectors need be sent from the host.

In Interactive mode the response of the circuit being simulated by the modified APPLES processor 19 during the course of the simulation influences the subsequent sequence of input vectors. The testbench can execute on the host PC 19 or alternatively the testbench can run on an embedded processor on the modified APPLES processor 19. If the testbench can pre-compute a set of input stimuli these can be loaded into the FIFO 35.

Referring now to FIG. 3 of the drawings there is shown a block diagram of an alternative system incorporating the processor according to the present invention, where like parts have been given the same reference numerals as before. This tool is a modified version of the basic system shown in FIG. 2. The calculated average power per cycle for the circuit is determined and a set of estimates generated. This set forms a sample space which can be statistically analysed. Using the t-distribution of Student, a user defined confidence level can be established. The width of this confidence level can be reduced through a feedback mechanism which stimulates more input vectors automatically until the confidence level is at a pre-determined width. The feedback mechanism comprises the power activity frames being transmitted to the Power analysis module 37 and from the results of the analysis the host PC determines whether the Confidence level criterion have been attained. If not, more random Input Vectors are generated and passed to the Input Vector List 33.

An efficient way of processing data in either simple or interactive testbench modes is the Accelerated Cycle-based mode. In order to perform the Accelerated Cycle-based mode a degree of preprocessing must be carried out. In this mode a circuit is levelised so that when an active cache block is evaluated, it needs only be evaluated once, and all fan-out gates are at a higher level. This implies each block is evaluated at most once during each cycle. This mode has the disadvantage that there is no longer a one to one correspondence between modules and cache blocks and toggle power can not be determined. The compiler 27 processes a Verilog netlist file. Regardless of the delay specification for the gates in the input file, the compiler 27 only extracts the topology and functionality of the circuit and generates a levelised network for execution on the modified APPLES processor 19. The main features of the levelising algorithm are outlined below:

Assign all primary inputs to Level₀
if Synchronous-Device ∉{ Gate fan-out Set } then
Gate-Level = Max (levelᵢₙ) + 1
else
Gate-level = Level₀ (and halt descent through this path)
endif

A recursive descent is made from the primary inputs through the entire circuit. If the circuit contains several pipeline stages, then level₀ of each stage is established by the immediate fanout gates of all flip-flops commencing each stage. All the same levels from different stages are combined into a single equivalent level. As the descent is made into the circuit, as each gate is encountered the level assignment outlined above is made. Several intermediate assignments may be made to gate, if the gate has fan-in gates from different levels. Assuming, there are no loops, the gates will have stabilized to their correct level, when all the gates at end of paths are at level₀.

In order to execute this mode, every level has a set of cache blocks associated with it. Blocks from successive levels are sequentially ordered in memory. For each clock period, cache blocks are processed from level₀ to the final level of the circuit. This final level is the maximum level of all the stages in the pipeline being analysed. Since the circuit has been levelised, all fan-outs are at higher levels or in level₀ if a gate is connected to a synchronous device feeding into the next stage. Consequently, after the processing of level₀ gates on commencement of the current clock cycle, the termination of the evaluation process is recognized when all the active gates are, again, all located in level₀. This gate evaluation mechanism is shown below:

```
repeat
At the start of each clock period do
evaluate_level₀_gates;
    repeat
        evaluate_active_gates;
        propagate_to_fan-out_gates;
        report_gate_activity;
    until all active gates are in level_{0.}
get_next_input_vector
until all_input-vectors_exhausted.
```

Referring now to FIG. 4 of the drawings there is shown a block diagram of the additional registers incorporated into the processor of the present invention which will help to more clearly illustrate the operation of the circuit. There are provided a plurality of Power Activity Frames 41 in the memory block area of the processor 19. Statistics for all the various gate types within a cache block are assembled in Power Activity Frames 41. Dynamic power data for a certain gate type and transition is gathered during the fan-out phase, each of the cache blocks has a power activity frame stored in memory. This memory is cleared prior to the commencement of a new cycle. Whenever an active block is loaded into the ENIGMA processor and evaluated, the cache block number is simultaneously loaded into the Block Number Register 43. On commencement of scanning of the Hit list 45, an Active Hit Counter register 47 is loaded with the running total for the particular gate type and transition from the appropriate cache block Power Activity Frame. The Block Number Register serves to index these frames. There is also provided a Block Activity counter 49 and a block dynamic activity table 51. The frames are cleared after the values have been transmitted to the host PC, which is normally at the end of a cycle.

Sometimes one or more particular gates may be monitored. This means any activity or state of these gates is identified and encoded in the activity frame. Gates can be indicated as being monitored by setting a code in the fan-out list of the gate or setting a code in Array1a (not shown) of the modified APPLES processor 19. Array1a defines gate type and input pins of a gate. Any activity of a monitored gate is encoded in the power activity frame and extracted from the frame by the host PC.

FIG. 5 is a component diagram of a complex cell that may be modeled according to the method of the present invention. Cell library cells composed of two or more primitive cells of the modified APPLES processor 19 (i.e. logic devices which can be evaluated through the application of a number of tests) are termed complex. In these devices it may be necessary to distinguish the primitive cells composing these devices from those library cells composed of a single primitive cell. This is to enable the complex cell to have different power characteristics from those of its constituent cells. In FIG. 5, the dynamic power consumption of the entire complex cell composed of four gates a, b, c and d, can be modeled through the dynamic power characteristics of gate d. Gate d can be assigned a different set of power values to another primitive 2-input AND gate by simply designating it a different gate type with the same functionality. Similarly, the leakage current or state of the entire cell is modeled through the primary input cells of the device, gates a and b. Gate c, although functional, has no power significance in the overall complex cell. It is assumed to have no power consumption.

Referring now to FIG. 6 of the drawings, there is shown a block diagram of a typical design methodology with the processor and method according to the invention incorporated in the design flow. The modified APPLES processor 19 is shown in both the initial power calculation stage and the final power calculation stage of the circuit design. The processor and method can be used in the initial power calculation stage with or without the wire loading information derived from initial global placement of the circuit's modular blocks. This permits accurate exploratory power analysis among various design options at an early stage of development. The processor and the method can further be employed later on in the process for final power calculation when a particular design has been advanced and placed and routed to provide a more accurate and detailed analysis.

In this specification, the processor is described at various times as a modified APPLES Processor. A number of significant amendments, some of which have already been discussed above, are made to the APPLES simulator so that power in a digital circuit can be effectively and accurately calculated. These hardware amendments and supporting software are incorporated into a system called ENIGMA (Energy Investigation for Gate and Module Analysis). The term ENIGMA will be used interchangeably with the term analysis system and Modified APPLES Processor system as they all equate to essentially the same thing, a processing system incorporating the modified APPLES Processor 19 of the present invention that is capable of carrying out the present invention. The amendments include the following:
1. For dynamic, toggle and leakage power analysis, it is not necessary to operate the APPLES simulator with full-gate and interconnect timing. It is sufficient to run the simulator with simple functional or unit delay timing. Furthermore, with this level of simplicity the simulator can run in a Cycle-based mode. This means that in a multi-stage pipeline circuit (i.e. a synchronous circuit), where each combinational stage is bounded by an input and output synchronous component block, every combinational stage is functionally simulated until all the effects of input changes to the stage have been propagated to the stage's outputs. When all combinational stages have stabilized, the outputs of each stage are propagated through the synchronous blocks to the inputs of the next stage. The period of time defined by the event of one or more inputs to any stage changing, to the stabilization of the output of all stages is termed a Cycle.
2. A circuit to be executed on the ENIGMA system is decomposed into an APPLES equivalent circuit. Gates are classified either as combinational or synchronous and are positioned into the cache blocks of the APPLES processor, so that any cache block contains exclusively combinational or synchronous components.
3. In order to efficiently trace the power behaviour of a group of gates or synchronous units constituting a module in the abstraction hierarchy of a circuit, these gates are collected into one or more APPLES cache blocks. Each block only contains components from a single module. Therefore, any activity in a block can be directly related to activity in a module of the circuit hierarchy.
4. Input stimuli to the ENIGMA system can be applied from a testbench through a propriety software interface such as Verilog's PLI and transferred to the Input-value bank of the APPLES processor. Alternatively, a block of input vectors can be pre-computed and stored in a FIFO (First In First Out) storage area on the same chip as the APPLES processor. Input vectors are stored in ascending time order and each vector has a time stamp indicating at which time the vector is to be applied to the APPLES Input value. This time can be specified as an integer, declaring at which cycle in the simulation it is to be applied. Alternatively if the simulation is not operating in cycle mode, the integer represents the time in the basic units of the simulation. In both cases the APPLES processor, maintains a register which contains the current reference time of the simulation. In the case of cycle-based simulation, this register is incremented by one cycle at the end of every simulated cycle. Alternatively, in asynchronous circuits it is incremented by one after time is incremented by a quanta of the simulation time in the APPLES processor.
5. In the original APPLES processor, for a given time interval active blocks in the cache are identified, gates in these blocks are consequently evaluated and activated gate outputs selected. Affected gates in the fan-out lists are subsequently updated. When all active blocks have be accordingly processed, all circuit activity for the current time interval has concluded and time is incremented by shifting all signal values by one unit. However, in the ENIGMA system operating in cycle-based mode, the unit of time resolution is the cycle. Therefore, in the gate evaluation process in ENIGMA, gates are divided into two classes, unit delay and synchronous. Unit delay devices are gates that change between clock cycles, while synchronous devices change at a clock edge. In addition, to Cache blocks containing just gates from one particular module, each only contains synchronous or unit delay devices.
After a circuit being simulated has been stimulated by an input vector, all synchronous cache blocks are evaluated and propagated to fan-out devices. Output changes of these devices affect unit delay devices. These, unit delay devices are evaluated and propagated. The propagation will activate cache blocks that contain either unit-delay or synchronous devices. At the end of the propagation stage, input values of fan-out gates are updated. All activated cache blocks containing unit delay devices are re-evaluated. This process is repeated until there are no more active unit delay cache blocks. This indicates that all combinational gates between the synchronous gates in the simulated circuit have stabilized and one simulated cycle has completed. At this juncture all the activated synchronous cache blocks are evaluated. These blocks have input data from either the outputs of unit delay devices or from a new input vector. The entire process is re-iterated until the desired number of simulated cycles has completed. This mechanism is outlined in the code segment below:

```
repeat
At the start of each clock period do
evaluate_synchronous_gates;
propagate_outputs_to_fan-out_gates;
    repeat
        evaluate_active_unit-delay_gates;
        (//These are identified in the cache block table//);
        propagate_to_fan-out_gates;
        update_power_activity_frames;
    until no_active_unit-delay_gates.
get_next_input_vector
until all_input-vectors_exhausted.
```

6. If a more rapid and memory efficient method is required, then it is possible to have a system which simply monitors the number of gates that are changing. The types of gates that are changing are ignored and therefore if different gates have different power characteristics, this method will not be able to distinguish between them. Before a new simulated cycle commences, a Block Activity Counter 49 (FIG. 4) and the entries in a Block Dynamic Activity Table 51 are cleared. When a cache block is loaded into the ENIGMA processor 19 for evaluation, the Block Activity Counter is loaded with the appropriate entry, the running total, in the Block Dynamic Activity Table 51 as indexed by the Block No. Register 43. The counter is incremented whenever any type of hit is encountered. At the end of the gate evaluation and fan-out phase it registers the Total activity of the cache and is intended to give measure of the dynamic power consumption of the block.
7. When leakage current is being evaluated a series of tests are applied to the cache memory blocks, identically as for the dynamic power analysis. In this case, each test is effectively directed to a particular gate input. This can be achieved in the basic APPLES processor design by activating a search in Array1a (which is an associative memory which contains gate type and input pin identification) on both a gate type and input pin. Therefore, for instance using the NAND gate example of Table 1, to determine which gates have input state 0111 requires 4 tests. However, after these gate evaluations there is no requirement to propagate updates to fan-out components, since leakage current by definition is a steady output state condition. The same registers as utilized in the dynamic power analysis are used in recording the leakage power. The relevant data areas are indicated as T₁, T₂ and Tₙ in the frames shown in FIG. 4. Input states can be calculated during the normal unit-delay gate evaluation phase or at the end of a cycle.
8. The data stored in the Power Activity Frames in the ENIGMA system identifies the transitions and states of the various gates in a circuit being simulated. This data is transferred at the end of every cycle to the host PC. To calculate the actual power being consumed in the circuit requires this data to be integrated into the equation:

Pₐᵥ=1/2T_{c}V²_{dd}Σⁿᵢ₌₁CᵢPᵢ(xᵢ)
or an equivalent equation. Cᵢ is the average capacitance for a cache block of gates/wires. It will be understood that the above equation is one of many equations that could be used for this purpose and that numerous other equations could also be used in it's place. What is important is how the variable components of the equation are derived. Sometimes the capacitance in the above equation is divided between the wire capacitance in a circuit and the capacitance of the logic devices. The power dissipation characteristics both dynamic and static of logic devices can be obtained from the Cell library of the target implementation technology. However, regardless of the nature of the power equation, the dynamic and state information is generated in the Power Activity frames which are sent to the host PC to instantiate the variables in the designated power equation. Another well known equation that could equally be used is:

P_{avg}=Pₛₕₒᵣₜ+P_{switch}+P_{static}=I_{sc}V_{dd}+αC_{L}V²_{dd}f+IₗₑₐₖV_{dd}
Where I_{sc} is the short circuit current, C_{L} is the load capacitance, f the clock frequency and α the node transition frequency factor. This could also be used to obtain a satisfactory result.
9. A unit delay model is adequate and sufficient to support any algorithm incorporating dynamic power. The delay characteristics of a gate have no significance in the calculation of leakage current which is a phenomenon of steady state conditions. A unit delay model will identify gates with transitions and enable dynamic power to be estimated. The ENIGMA power tool uses a cache process which re-evaluates active gates every time any input changes. The ENIGMA process does not defer gate evaluation until all input transitions have been made. This has the affect that APPLES calculates toggle power. When simultaneous multiple input changes occur at a gate it is possible that toggle power for that particular transition is ignored.

The activity frames from the APPLES processor convey the cycle accurate details regarding the dynamic and state behaviour being simulated. When the host PC receives these frames, the data is used to instantiate various power equations. If the circuit being simulated has not been placed and routed then only the power consumed by the gates can be calculated. If however, the circuit has been placed and routed, and for instance, an SDF file with interconnect information exists, or alternatively, estimates for the wire load are available then this information can be incorporated into the power equations.

An efficient method for incorporating wire loads into the equations is to use an average value for each cache block. If there are any gates, in a cache block that have a loading value considerably larger or smaller than the block's average, then these gates can be monitored individually in the block's activity frame and their power contribution selectively calculated. In addition, this application describes the use of Verilog, however, it will be understood that any other gate level net list description could be used instead, such as VHDL and the like.

Throughout this specification the terms “include, includes, included and including” as well as the terms “comprise, comprises, comprised and comprising” are all deemed totally interchangeable and should be afforded the widest possible interpretation.

It will be understood by the skilled addressee, that other minor modification could be made to the processor and the method without departing from the spirit and scope of the invention. The invention is in no way limited to the embodiments hereinbefore described but may be varied in both construction and detail within the scope of the claims.

1. A method of determining the power dissipation characteristics of a digital circuit in a processor (19) comprising a main processor and an associative memory mechanism (101a, 101b, 102, 104), the associative memory mechanism comprising a plurality of associative arrays (101a, 101b), an input value register (102), at least one result register (104) and a memory block area (29), the method comprising the steps of:
providing a digital circuit design (25) for analysis, the circuit design containing a plurality of components complete with a component library containing power dissipation characteristics for each of the components in the circuit design;
parsing the digital circuit design to create a functionally equivalent model in a format suitable for manipulation in the main processor and associative memory mechanism, the functionally equivalent model containing a plurality of primitive types (a, b, c, d), each primitive type having at least one input gate and an output gate;
storing the functionally equivalent model in the associative memory mechanism (101a, 101b, 102, 104);
providing at least one input vector (33) to the functionally equivalent model and determining which of the primitive types undergo a change in one or more of the gate values in response to the input vector applied;
storing a record of values on each of the gates of the primitive types in response to the applied input vector; and
calculating the power dissipation of the model by comparing the power dissipation characteristics with the record of values on each of the gates of the primitive types.

2. The method of determining the power dissipation characteristics of a digital circuit as claimed in claim 1 in which the method comprises the step of determining the primitive types (a, b, c, d) that have undergone a change in output gate value and calculating the transition dynamic power consumption for those primitive types.

3. The method of determining the power dissipation characteristics of a digital circuit as claimed in claim 2 in which the method further comprises the step of storing a record of all transitions in a primitive types (a, b, c, d) output over a simulation time unit (STU) and calculating the toggle dynamic power consumption for that primitive type.

4. The method of determining the power dissipation characteristics of a digital circuit as claimed in claim 2 in which the method further comprises the step of determining the nature of the transition of the output and thereafter calculating the dynamic power consumption based on the nature of the transition.

5. The method of determining the power dissipation characteristics of a digital circuit as claimed in claim 1 in which the method further comprises the step of storing a record of all input gate values for a primitive type (a, b, c, d) and calculating the leakage power consumption for that primitive type.

6. The method of determining the power dissipation characteristics of a digital circuit as claimed in any preceding claim 1 in which the step of calculating the power dissipation of the model further comprises calculating both the dynamic power dissipation and the leakage power dissipation.

7. The method of determining the power dissipation characteristics of a digital circuit as claimed in claim 1 in which the method further comprises the step of segmenting the functionally equivalent model into a plurality of cache blocks, each of the cache blocks containing a plurality of related primitive types.

8. The method of determining the power dissipation characteristics of a digital circuit as claimed in claim 7 in which the step of segmenting the circuit into a plurality of cache blocks, each of the cache blocks containing a plurality of related primitive types (a, b, c, d) further comprises separating the primitive types into cache blocks based on whether the primitive types are synchronous or combinational.

9. The method of determining the power dissipation characteristics of a digital circuit as claimed in claim 7 in which the step of segmenting the circuit into a plurality of cache blocks, each of the cache blocks containing a plurality of related primitive types (a, b, c, d) further comprises separating the primitive types which form a single module into a cache block together.

10. The method of determining the power dissipation characteristics of a digital circuit as claimed in claim 1 in which the method comprises the intermediate step of generating a power activity frame (41) prior to calculating the power dissipation of the model, the power activity frame (41) comprising a list of all primitive types that have undergone a transition in their gate value.

11. The method of determining the power dissipation characteristics of a digital circuit as claimed in claim 10 in which the method further comprises the intermediate step of transmitting the power activity frame (41) for each cache block to a host PC and the steps of calculating the power dissipation for each cache block based on the power activity frame (41) corresponding to that cache block and thereafter calculating the power dissipation for the entire circuit are carried out on the host PC.

12. The method of determining the power dissipation characteristics of a digital circuit as claimed in claim 10 in which the power activity frames (41) are transferred to the host PC (31) after each cycle.

13. The method of determining the power dissipation characteristics of a digital circuit as claimed in claim 1 in which the method further comprises the steps of:
deriving a library characterisation file (LCF) from the component library, the LCF specifying the power dissipation characteristics of each of the primitive types (a, b, c, d) of the functionally equivalent model; and
generating a transition count file (TCF) that lists the number of transitions on each of the gates of the primitive types (a, b, c, d) per simulation time unit (STU); and
calculating the power dissipation of each STU by comparing the LCF with the TCF.

14. The method of determining the power dissipation characteristics of a digital circuit as claimed in claim 1 in which the step of parsing the digital circuit design to create a functionally equivalent model further comprises generating an Apples to Design cell relational Database (ADD) containing the relationships between the components of the digital circuit design with the primitive types (a, b, c, d) of the functionally equivalent model, and a Design Cell Database (DCD) containing a list of components of the original digital circuit design, the method further comprising the steps of:
generating an Apples Model Value Change File (AMVCF) containing a list of gate value changes of primitive types in the functionally equivalent model;
processing the AMVCF entry by entry and for each entry in the AMVCF, using the ADD to determine which of the components in the original digital circuit design the entry in the AMVCF relates to; and
retrieving that component from the DCD and thereafter calculating the power dissipation of that component using the component library.

15. The method of determining the power dissipation characteristics of a digital circuit as claimed in claim 1 in which the step of applying an input vector (33) to the circuit further comprises receiving an input vector from a host PC (31) and applying that input vector to the circuit.

16. The method of determining the power dissipation characteristics of a digital circuit as claimed in claim 1 in which the step of applying an input vector (33) to the circuit further comprises generating an input vector for application to the circuit.

17. The method of determining the power dissipation characteristics of a digital circuit as claimed in claim 1 in which the method is carried out on a cycle by cycle basis.

18. The method of determining the power dissipation characteristics of a digital circuit as claimed in 1 in which a one of a simple functional or unit delay is used.

19. The method of determining the power dissipation characteristics of a digital circuit as claimed in claim 1 in which the step of calculating the power dissipation for the entire circuit further comprises determining the total power dissipation for each of the particular types of components in the circuit and thereafter summing the total power dissipation for each type of component with the total power dissipation for all the other types of components.

20. The method of determining the power dissipation characteristics of a digital circuit as claimed in claim 1 in which the step of calculating the power dissipation for the entire circuit further comprises determining the total number of gates undergoing a transition regardless of gate type and using an approximation of a mean gate power dissipation value to calculate the power dissipation.

21. The method of determining the power dissipation characteristics of a digital circuit as claimed in claim 1 in which a plurality of primitive components (a, b, c, d) may be grouped in a complex cell and the method further comprises the step of determining the power dissipation of the complex cell based on a predetermined power characteristic for that cell.

22. The method of determining the power dissipation characteristics of a digital circuit as claimed in claim 1 in which the method further comprises the initial step of levelising the circuit to be evaluated.

23. A method of determining the power dissipation characteristics of a digital circuit, in a processor (19) comprising a main processor and an associative memory mechanism (101a, 101b, 102, 104), the associative memory mechanism further comprising a plurality of associative arrays (101a, 101b), at least one result register (104) and a memory block area (29), the memory block area being capable of storing a plurality of power activity frames (PAF) (41), the power activity frames (41) representing the status of individual components forming the digital circuit, the method comprising the steps of:
segmenting the circuit into a plurality of cache blocks, each of the cache blocks containing a plurality of related components;
storing the cache blocks in the associative memory mechanism (101a, 101b, 102, 104);
applying an input vector (33) to the circuit and determining which of the cache blocks will undergo a transition as a result of the input vector applied;
evaluating each cache block that undergoes a transition due to the application of the input vector (33) and storing the results of the evaluation in a power activity frame (41) in the memory block area (29); and
calculating the power dissipation for each cache block based on the power activity frame (41) corresponding to that cache block and thereafter calculating the power dissipation for the entire circuit.

24. A processor (19) for determining the power dissipation characteristics of a digital circuit comprising a plurality of components, the processor (19) comprising a main processor and an associative memory mechanism (101a, 101b, 102, 104), the associative memory mechanism comprising a plurality of associative arrays (101a, 101b), an input value register (102), at least one result register (104) and a memory block area (29), characterized in that the processor (19) further comprises a parser (27) for receiving a digital circuit design in a first format and creating a functionally equivalent model comprising a plurality of primitive types (a, b, c, d), each having at least one input gate and an output gate, in a second format suitable for manipulation in the main processor (19) and associative memory mechanism (101a, 101b, 102, 104).

25. The processor (19) for determining the power dissipation characteristics of a digital circuit as claimed in claim 24 in which the processor (19) further comprises means to store the power dissipation characteristics for primitive types of the functionally equivalent model and means to calculate the power dissipation of the primitive types of the functionally equivalent model.

26. The processor (19) for determining the power dissipation characteristics of a digital circuit as claimed in claim 24 in which the processor further comprises means to generate an APPLES Model Value Change File (AMVCF) containing a list of transitions in the values of gates in the functionally equivalent model.

27. The processor (19) for determining the power dissipation characteristics of a digital circuit as claimed in claim 24 in which the processor has means to generate a transition count file (TCF) comprising a list of the number of transitions of each of the gates of the primitive types for a given simulation time unit (STU).

28. The processor (19) for determining the power dissipation characteristics of a digital circuit as claimed in claim 24 in which the processor has means to generate a library characterization file (LCF) from a received library file relating to a digital circuit design.

29. The processor (19) for determining the power dissipation characteristics of a digital circuit as claimed in claim 24 in which the processor further comprises an APPLES to Design cell relational Database (ADD), a Design Cell Database (DCD) and a Hierarchy model (HM).

30. The processor (19) for determining the power dissipation characteristics of a digital circuit as claimed in claim 29 in which the processor has means to access power dissipation characteristic tables of components of a digital circuit design and using the AMVCF, the ADD and the DCD, calculate the power dissipation for a digital circuit design.

31. The processor (19) for determining the power dissipation characteristics of a digital circuit as claimed in claim 24 in which the processor further comprises a block activity counter (49), an active hit counter (47) and a block dynamic activity table (51).

32. The processor (19) for determining the power dissipation characteristics of a digital circuit as claimed in claim 24 in which the processor has means for receiving an input vector (33) from a host PC (31) for application to a circuit under test.

33. The processor (19) for determining the power dissipation characteristics of a digital circuit as claimed in claim 24 in which the processor has means for generating an input vector for application to a circuit under test.

34. The processor (19) for determining the power dissipation characteristics of a digital circuit as claimed in claim 24 in which the processor (19) has means for transmitting activity data relating to gates to a host PC (31) for further analysis by the host PC (31).
